(19) United States
(12) Patent Application Publication
(10) Pub. No.: US 2004/0257685 A1
(43) Pub. Date: Dec. 23, 2004

(54) Mirror spot within mirror

(76) Inventors: Roger G. Minor, Decatur, AL (US); Ronald Freeman, Athens, GA (US)

Correspondence Address: LANIER FORD SHAVER & PAYNE, P O BOX 2087, HUNTSVILLE, AL, 35804, US

(21) Appl. No.: 10/810,316

(22) Filed: Mar. 26, 2004

Related U.S. Application Data
(60) Provisional application No. 60/458,225, filed on Mar. 27, 2003.

(51) Int. Cl. G02B 5/10

(52) U.S. Cl. 359/869; 359/864

(57) ABSTRACT

A single construct mirror within a mirror is provided for use in enhancing the safe operation of motor vehicles by eliminating “blind spots.” Such construct includes a secondary mirror formed within a primary mirror by the removal of or formation of a concave indentation on the rear surface of a generally flat sheet of glass, plastic or other suitable material. Such sheet may then be mirrored by silvering the rear surface including the concave indentation. The front reflective surfaces of both mirrors are generally flat and co-planar.

### REFERENCE TO RELATED APPLICATION

This application claims priority to U.S. Provisional Patent Application Ser. No. 60/458,225, entitled “Mirror Spot Within Mirror,” filed Mar. 27, 2003.

### BACKGROUND OF THE INVENTION

1. Field of the Invention

The present invention generally relates to mirrors. In particular, the present invention relates to mirror constructions for use in transportation vehicles. More particularly, the present invention relates to a new single construct mirror with an embedded mirror within a mirror, wherein said embedded mirror operates to reflect a wider viewing area than the main portion of such mirror.

2. Description of the Prior Art

Rearview mirrors are essential for the safe operation of motor vehicles. Ordinary flat rearview mirrors are known to have a “blind spot” located adjacent the vehicle and to the rear of the driver. Such “blind spot” often leads to accidents, particularly when a driver is changing lanes and is unaware of a nearby motorist or other traffic.

Numerous solutions to eliminate such a “blind spot” have evolved, including the use of convex mirrors adhered to the surface of a flat rearview mirror to enhance the viewing area of the mirror. Further still, other attempts have been made to add additional mirrors at slightly offset angles to incorporate the “blind spot” in the reflected view of the rearview mirror. Still other efforts have tried to incorporate curved mirrors in a manner similar to the offset angled mirrors to further enhance the width of the reflected view in the rearview mirror.

Most of these solutions, however, result in either a reduction of the useful viewing area of the flat rearview mirror, the addition of additional mirrors which increases manufacturing costs and complexity, or the inclusion of complex curved surfaces on mirrors which similarly drive up manufacturing costs.

It is, therefore, desirable to provide a flat rearview mirror incorporating the benefits of an enhanced viewing area without the need for additional constructions or complicated construction techniques. Therefore, the present invention provides a single construction mirror within a mirror that provides an enhanced reflected viewing area within one portion of the mirror while maintaining a sufficient reflected viewing area in the remainder of the mirror to allow for safe operation of a motor vehicle including the present invention.

### SUMMARY OF THE INVENTION

The present invention recognizes and addresses various of the foregoing limitations and drawbacks, and others, concerning mirrors and more particularly, rearview mirrors for motor vehicle operations. Therefore, the present invention is directed to a single construction rearview mirror within a mirror that provides an enhanced reflected viewing area within one portion of the mirror while maintaining a sufficient reflected viewing area in the remainder of the mirror to allow for safe operation of a motor vehicle including the present invention.

It is, therefor, a principle object of the subject invention to provide a mirror within a mirror. More particularly, it is an object of the present invention to provide a single construction mirror incorporating a secondary mirror for enhanced reflected viewing area. In such context, it is still a more particular object of the present invention to provide a single construct mirror within a mirror whose reflective surface is flat.

Still further, it is a principle object of this invention to provide a rearview mirror having an improved ability to eliminate any “blind spot”. It is a further object of the present invention to provide such “blind spot” elimination in a single construct of simple design and manufacture. In such context, it is an object of the present invention to provide such a rearview mirror that is cost-efficient to manufacture.

Additional objects and advantages of the invention are set forth in, or will be apparent to those of ordinary skill in the art from, the detailed description as follows. Also, it should be further appreciated that modifications and variations to the specifically illustrated and discussed features and materials hereof may be practiced in various embodiments and uses of this invention without departing from the spirit and scope thereof, by virtue of present reference thereto. Such variations may include, but are not limited to, substitutions of the equivalent means, features, and materials for those shown or discussed, and the functional or positional reversal of various parts, features, or the like.

Still further, it is to be understood that different embodiments, as well as different presently preferred embodiments, of this invention, may include various combinations or configurations of presently disclosed features, elements, or their equivalents (including combinations of features or configurations thereof not expressly shown in the figures or stated in the detailed description).

These and other features, aspects and advantages of the present invention will become better understood with reference to the following descriptions and appended claims. The accompanying drawings, which are incorporated in and constitute a part of this specification, illustrate an embodiment of the invention and, together with the descriptions, serve to explain the principles of the invention.

In one exemplary embodiment, there may be provided a single construction mirror encompassing a secondary mirror capable of enhancing the reflected viewing area to include any blind spots not revealed in the primary mirror. Such secondary mirror may be included at any location on the surface of the primary mirror as desired by the manufacturer or as required for use with a particular vehicle. Both the primary mirror and the secondary mirror (the mirror within a mirror) have a flat front reflective surface.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a plain view of a mirror within a mirror as provided in the present invention;

FIG. 2 is a plain view of the mirror within a mirror of FIG. 1, wherein the secondary mirror is located in a different location within the primary mirror; and

FIG. 3 is a partial side view of the mirror within a mirror as depicted in FIGS. 1 and 2 showing the concave rear surface of the secondary mirror of the present invention.

Repeat use of reference characters throughout the present specification and appended drawings is intended to represent the same or analogous features or elements of the invention.

### DETAILED DESCRIPTION OF THE PREFERRED EMBODIMENTS

Reference will now be made in detail to presently preferred embodiments of the invention, examples of which are fully represented in the accompanying drawings. Such examples are provided by way of an explanation of the invention, not limitation thereof. In fact, it will be apparent to those skilled in the art that various modifications and variations can be made in the present invention, without departing from the spirit and scope thereof. For instance, features illustrated or described as part of one embodiment can be used on another embodiment to yield a still further embodiment. Still further, variations in selection of materials and/or characteristics may be practiced, to satisfy particular desired user criteria. Thus, it is intended that the present invention cover such modifications and variations as come within the scope of the present features and their equivalents.

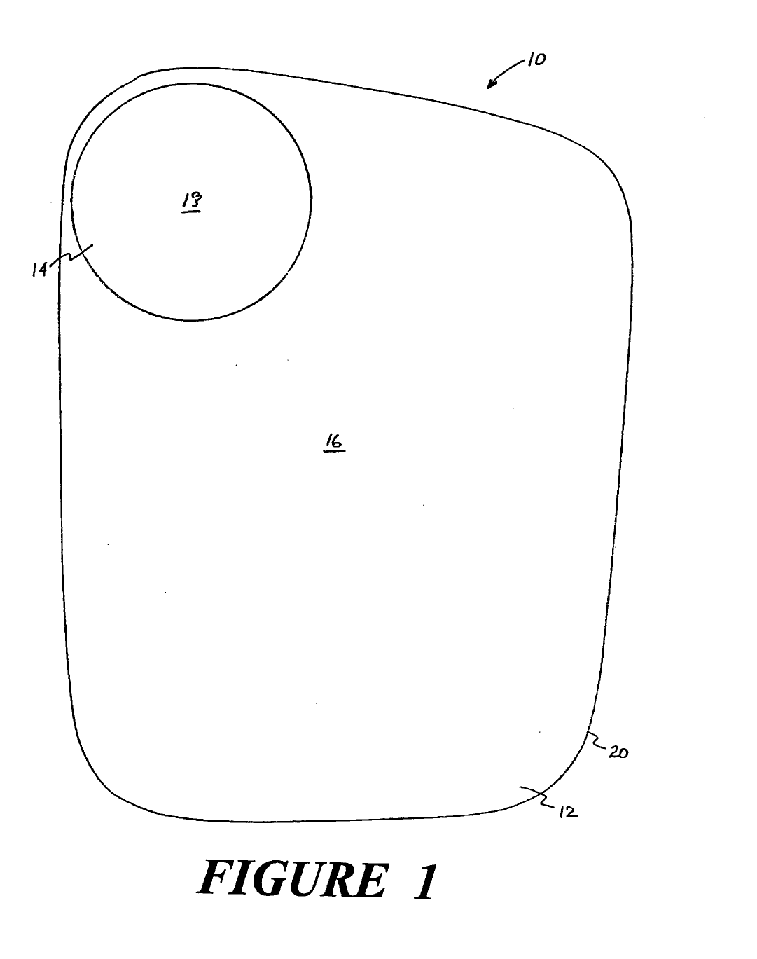

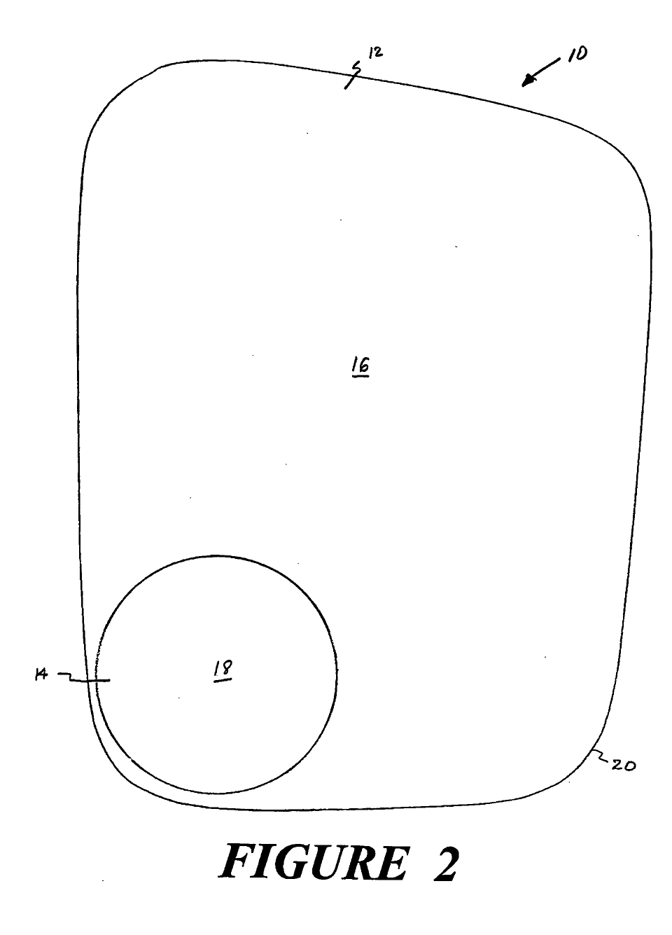

As disclosed above, the present invention is particularly concerned with a single construct mirror within a mirror 10 for use with motor vehicles, such construct 10 providing both normal and enhanced rearward views thus eliminating any blind spots. As seen in FIGS. 1 and 2, such a construct 10 may provide a primary mirror 12 that incorporates therein a secondary mirror 14 capable of reflecting a wider viewing area. Such secondary mirror 14 (as depicted) may be located in any position within the primary mirror 12 as desired by the manufacturer or as required for use with a particular motor vehicle. Further, while such secondary mirror 14 may be any shape desired, a circular shape is preferred to reduce any distortion introduced to the reflected image.

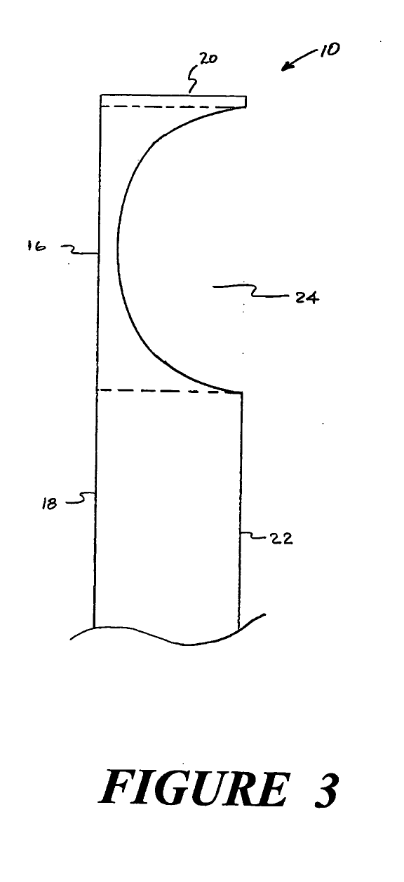

As best seen in FIG. 3, the front reflective surface 16 of the primary mirror 12 is generally flat. Similarly, the front surface 18 of the secondary mirror 14 is also generally flat and co-planar with the front reflective surface 16 of the primary mirror 12. Such a characteristic of the present invention is inherently achieved by the construction process.

A generally planar piece of glass, plastic or other suitable material may be used as the basis for the present invention. In one preferred embodiment, a glass sheet 20 of appropriate size is used and an area on the back surface 22 of such glass sheet is ground out to form a generally concave circular indentation 24 into the glass sheet 20. The glass sheet 20 is then mirrored typically by applying a coating such as silver or another reflective material to the back face of the glass sheet including within the concave circular indentation 24. Such indentation 24 forms a convex reflective surface when viewed from the front of the mirrored glass sheet, but in fact provides a flat front reflective surface 18.

As mentioned above, an alternative preferred embodiment would include the use of a plastic material that may be produced with such an indentation 24 as above described through an injection molding process. Such a methodology would reduce both manufacturing complexity by eliminating the grinding step required to introduce the indentation in the glass sheet, as well as, reducing cost.

Although a preferred embodiment of the invention has been described using specific terms and devices, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of various other embodiments may be interchanged both in whole or in part. Therefore, the spirit and scope of the appended claims should not be limited to the description of the preferred version contained herein.

What is claimed is:

1. A mirror within a mirror construct, comprising:
a sheet of material capable of being mirrored, said sheet having a first side and a second side;
a concave indentation in said second side, wherein the depth of said concave indentation is less than the thickness of said sheet of material; and
wherein said sheet of material with said concave indentation is mirrored through the application of a reflective material on said second side.

2. The construct of claim 1, wherein said sheet of material is glass.

3. The construct of claim 2, wherein said concave indentation is formed by grinding said glass sheet to remove material on said second side.

4. The construct of claim 3, wherein said reflective material is silver.

5. The construct of claim 1, wherein said sheet of material is plastic.

6. The construct of claim 5, wherein said sheet of material is injection molded to include said concave indentation on said second side.

7. The construct of claim 6, wherein said reflective material is silver.

8. A rearview mirror, comprising:
a single construction mirror having a portion of such mirror capable of reflecting a wider field of view, and wherein said mirror is comprised of a single sheet of material having a flat first side and which is mirrored on a second side.

9. The rearview mirror of claim 8, wherein said portion of said mirror capable of reflecting a wider field of view is a generally circular concave indentation on said second side of said sheet of material.

10. The rearview mirror of claim 9, wherein said concave indentation appears convex from said first said of said construction, but wherein said first side of said construction is generally flat.

11. The rearview mirror of claim 10, wherein said sheet of material is glass.

12. The rearview mirror of claim 11, wherein said concave indentation is generated by grinding material out of the second side of said glass.

13. The rearview mirror of claim 10, wherein said sheet of material is injection-molded plastic.

14. A unitary construction mirror, comprising:
a primary mirror made of a sheet of material, said sheet of material having a first and a second side; and
a secondary mirror; and
wherein said secondary mirror is capable of reflecting a wider field of view than said primary mirror and wherein said secondary mirror is formed in the same said sheet of material as said primary mirror.

15. The unitary mirror of claim 14, wherein said sheet of material is glass.

16. The unitary mirror of claim 15, wherein said secondary mirror is formed by grinding a generally circular concave indentation into said second side.

17. The unitary mirror of claim 16, wherein said secondary mirror appears convex from said first side, but wherein said secondary mirror is generally flat on said first side.

18. The unitary mirror of claim 17, wherein said sheet of material is mirrored by applying a coating of silver to said second side thereof.

19. The unitary mirror of claim 14, wherein said sheet of material is injection-molded plastic and wherein said secondary mirror is formed therein by the inclusion of a concave indentation in said second side of said sheet of material.

20. The unitary mirror of claim 19, wherein said sheet of material is mirrored by applying a coating of silver to said second side thereof.
